(19) United States
(12) Patent Application Publication
(10) Pub. No.: US 2012/0175878 A1
(43) Pub. Date: Jul. 12, 2012

(54) WIND POWER PLANT AND A METHOD OF OPERATING A WIND POWER PLANT

(76) Inventor: Anders Wickstrom, Karlstad (SE)

(21) Appl. No.: 13/376,927

(22) PCT Filed: Jun. 3, 2010
(86) PCT No.: PCT/EP10/57791

§ 371 Date: Mar. 21, 2012

(30) Foreign Application Priority Data
Jun. 8, 2009 (SE) 0950422-6

(51) Int. Cl. H02P 9/04; F03D 7/04

(52) U.S. Cl. 290/44; 416/1; 416/39

(57) ABSTRACT

A method for operating a wind power plant having turbine blades is provided. The method includes performing a monitoring operation to determine whether ice has formed on the turbine blades and, if there is ice on the turbine blades, removing the ice. To remove the ice, the turbine blades are driven alternatingly in opposite directions such that vibrations in the turbine blades are generated. A wind power plant designed to carry out the method is also provided.

The present invention relates generally to a wind power plant (a windmill, wind turbine). The invention also relates to a method of operating the wind power plant. The method involves deicing the turbine blades of the wind power plant.

If an ice sheet is formed on the surface of an aerodynamic body such as a wing or a turbine blade in a wind power plant, this will have a negative effect on the air flow over the aerodynamic body. In a wind power plant, ice on the turbine blades can cause imbalances that reduce the power output from the power plant. If large amounts of ice form on the turbine blades, it may even become impossible to continue operation and the wind power plant must be shut down until the ice has been removed from the turbine blades. When the load caused by imbalances becomes too large, this may cause damages to the power plant itself. It may also happen that the profile of the blades is altered in such a way that the blades are not so easily rotated by the wind.

In EP 1377503, it has been suggested that a microwave system be used to keep parts of a hollow body ice-free. The hollow body may be a turbine blade in a wind power plant. Ice sensors may be used in this known device. U.S. Pat. No. 7,057,305 discloses a wind power installation where heated air may be used to heat the rotor blades during the cold season to eliminate ice buildup.

U.S. Pat. No. 6,890,152 discloses a deicing device for wind turbine blades in which a turbine blade, or a portion thereof, is caused to vibrate such that ice built up on the wind turbine blade is caused to break off. To cause the turbine blades to vibrate, each of the turbine blades includes one or more vibrators. The vibrators include one or more acoustic wave generators such as sonic horns.

The prior art devices for de-icing the turbine blades of a wind power plant require additional equipment on the blades themselves for performing the de-icing operation. Moreover, the solutions according to the prior art may require some time before the ice has melted unless they are applied constantly. The known solutions may also require a relatively large amount of energy to remove the ice.

It is an object of the present invention to provide an alternative to the solutions known from the prior art. It is another object of the invention to provide a way of de-icing the rotor blades that is fast and effective. These and other objects are addressed by various aspects of the present invention as will be explained in the following.

One aspect of the invention relates to a method of operating a wind power plant and more specifically to a method for de-icing turbine blades of a wind power plant, i.e. to remove ice that has formed on the turbine blades. The method may advantageously comprise an initial a monitoring operation that is carried out in order to determine if a criterion that indicates that ice has formed on the turbine blades is satisfied. If this criterion is satisfied, a de-icing operation is performed on the turbine blades. The monitoring operation may comprise, for example, monitoring the turbine blades or a zone around the wind power plant. Alternatively, the monitoring operation may comprise measuring the output from the wind power plant and comparing the measured output to the output that would have been expected. The expected output may be based on, for example, wind speed. If it is found that output from the wind power plant is lower than it ought to be in view of the speed of the wind, this can be interpreted as a sign that ice has formed on the turbine blades. The output can also be compared with the expected output at a given rotational speed of the turbine blades or some other parameter that is known to correlate with output.

According to an aspect of the invention, the de-icing operation comprises driving the turbine blades of the wind power plant alternatingly in opposite directions such that vibrations in the turbine blades are generated.

Before the de-icing operation is carried out, the turbine blades may optionally be turned such that, in the plane in which the turbine blades rotate, the bending stiffness of the turbine blades is reduced and preferably minimized From a starting position in which the turbine blades are facing the wind, this normally means that the turbine blades are turned away from the direction of the wind such that the area of the turbine blades that faces the wind is reduced. Preferably, the area facing the wind is minimized.

Optionally, if the turbine blades are rotating when the criterion that indicates that ice has formed is satisfied, the speed of the rotation of the turbine blades is reduced before the de-icing operation is carried out.

Optionally, the turbine blades are first halted completely before the de-icing operation is carried out.

During the de-icing operation, the turbine blades are driven alternatingly in opposite directions at a frequency that, optionally, is selected to generate self-oscillation in the turbine blades.

During the de-icing operation, the turbine blades may optionally be driven by a generator of the wind turbine which generator is driven by the turbine blades during normal operation of the wind power plant and wherein, during the de-icing operation, the generator drives the turbine blades.

After the de-icing operation has been carried out, the turbine blades may optionally be monitored to determine whether there is still ice on the turbine blades and, if it is determined that the turbine blades are sufficiently ice-free, the wind power plant is operated to generate electricity.

Another aspect of the invention relates to a wind power plant having a generator and turbine blades arranged to drive the generator such that electrical power is generated. Optionally, the wind power plant may also comprise equipment arranged to detect whether a criterion that indicates ice formation on the turbine blades is satisfied. This equipment may comprise one or several ice detectors arranged to detect the presence of ice on the turbine blades or a condition in a zone around the wind power plant that is indicative of ice on the turbine blades. Equipment for detecting whether a criterion indicative of ice formation is satisfied does not necessarily have to comprise detectors that directly detect ice. For example, the wind power plant may comprise equipment/devices arranged to measure the output from the wind power plant and compare the actual output to an expected output. The expected output could be determined according to, for example, the speed of the wind, the rotational speed of the turbine blades or an average of previously recorded levels of the output.

According to an aspect of the invention, the generator is arranged to be able to drive the turbine blades alternatingly in two opposite directions.

Optionally, the generator and the turbine blades are directly coupled to each other without any intermediate gear.

Optionally, the wind power plant further comprises a control unit connected to the detector(s) and to the generator and, in response to a signal from the detector (or detectors) that indicates the presence of ice on one or several turbine blades, cause the generator to drive the turbine blades alternatingly in two opposite directions.

In this context, the term “a signal” should be understood as meaning “at least one signal” since there could of course be many signals that each indicate that ice has formed. It should also be understood that the term can refer to a plurality of different signals that, when evaluated together, indicate that ice has formed.

Various aspects and embodiments of the present invention will now be described in connection with the accompanying drawings, in which:

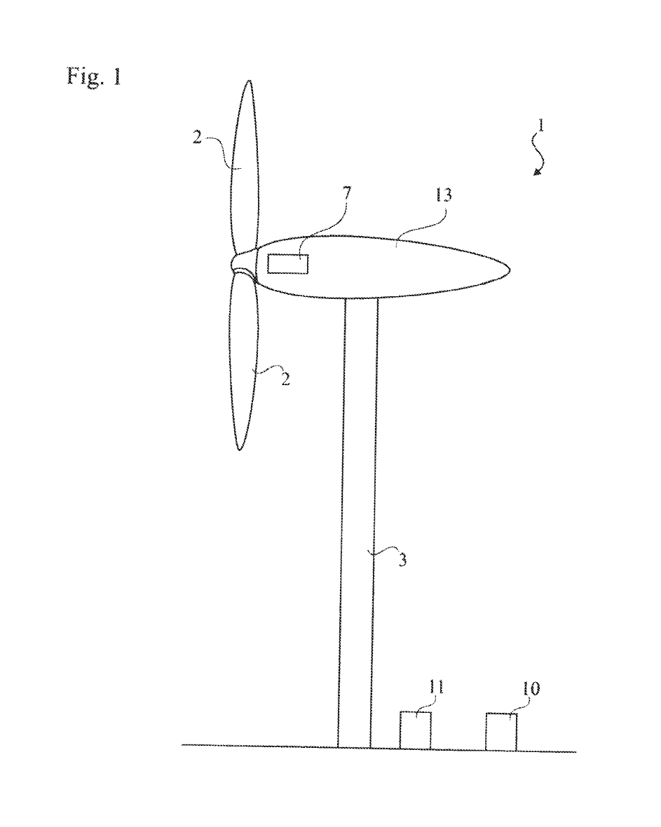

FIG. 1 shows, schematically, a wind power plant.

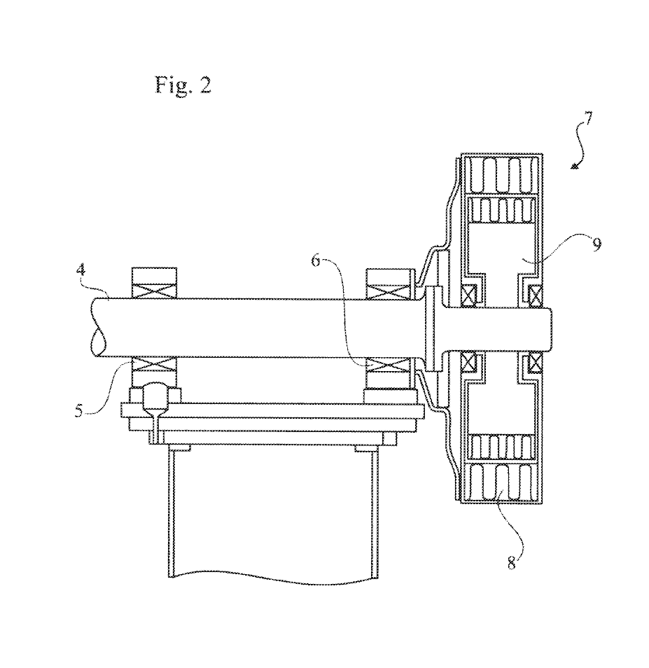

FIG. 2 is a cross-section of a part of the wind power plant.

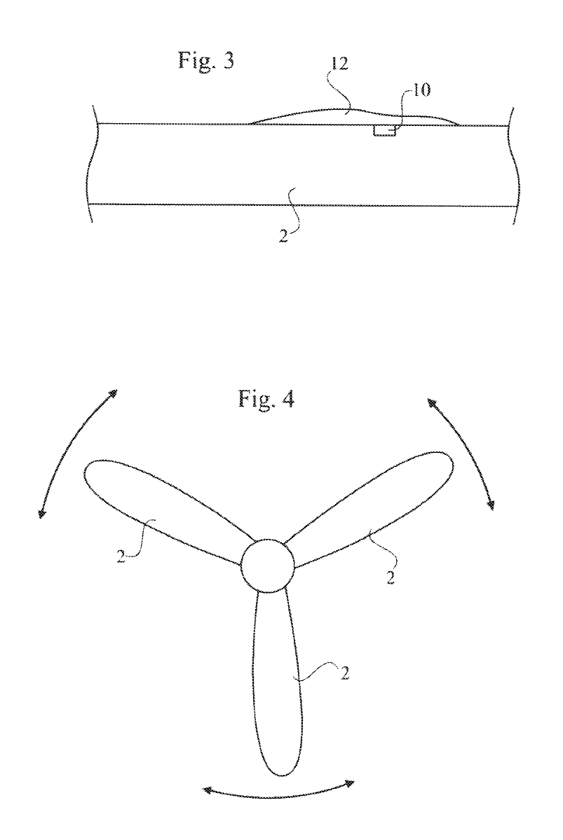

FIG. 3 is a cross-sectional view of a turbine blade.

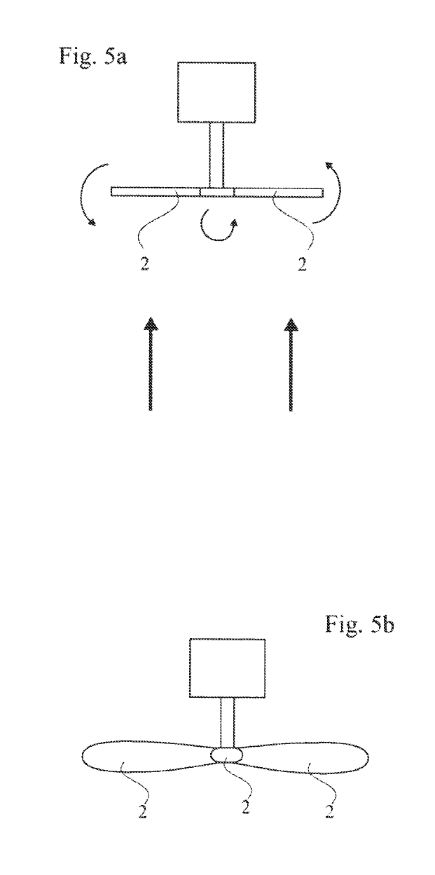

FIG. 4 is a schematic illustration of the basic principle of various aspects of the invention.

FIGS. 5a-5b show, from above, how the turbine blades can be turned away from the wind.

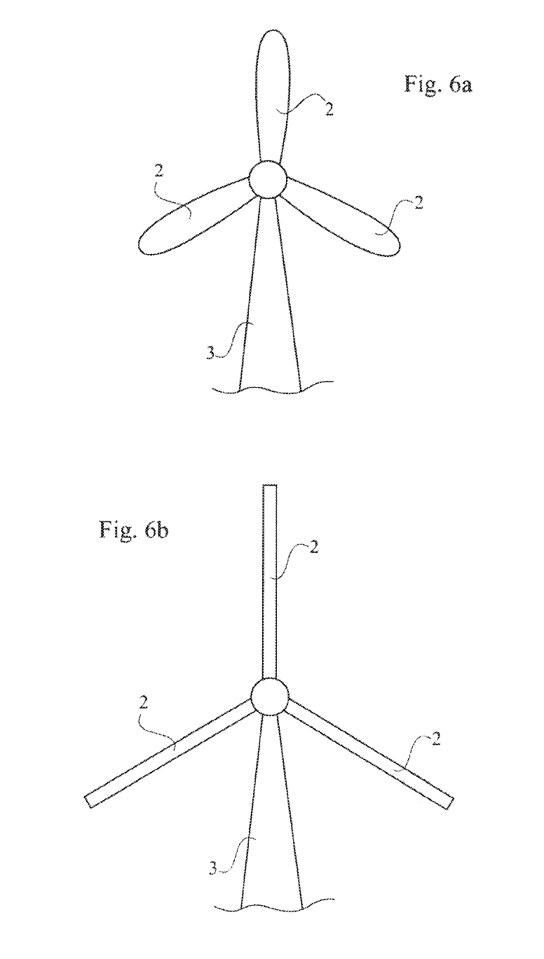

FIGS. 6a-6b are front views corresponding to FIGS. 5a and 5b.

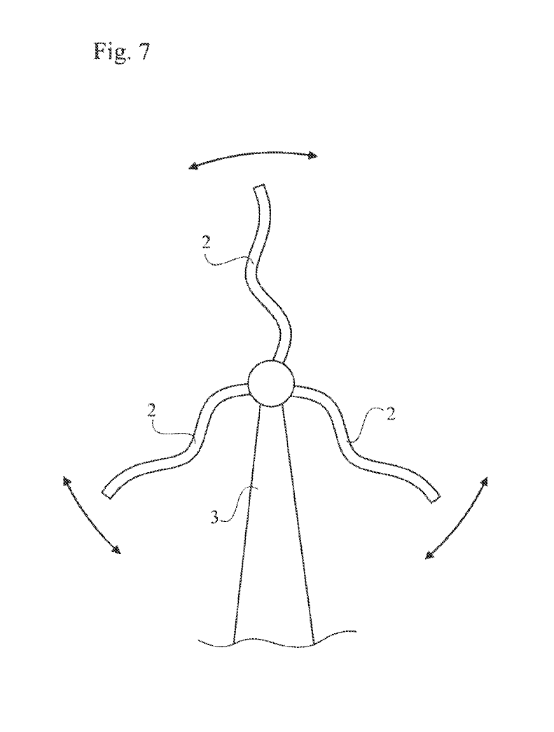

FIG. 7 is a front view that schematically shows the operation of an inventive method according to aspects of the present invention.

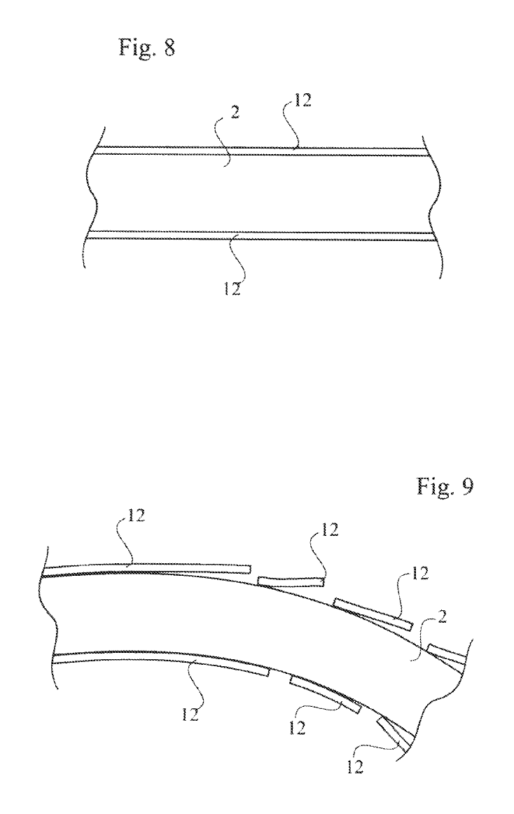

FIG. 8 is a cross-sectional view of a turbine blade that is covered by a sheet of ice.

FIG. 9 is a cross-sectional view corresponding to FIG. 8 and showing how a turbine blade is de-iced.

With reference to FIG. 1, a wind power plant 1 has turbine blades 2 that are rotatably mounted on a support 3 such as a tower. In the embodiment showed in FIG. 1, the tower 3 has a nacelle 13 in which a turbine shaft of the turbine blades 2 may be rotatably journalled. In principle, the wind power plant may have any dimensions. However, in many realistic embodiments, the turbine blades 2 may have a length in the range of 10 m-60 m, for example 15 m-50 m. It should be understood that embodiments are also possible where the turbine blades 2 may be longer than 60 m or shorter than 10 m. The turbine blades 2 are arranged to drive a generator 7 that may be located inside the nacelle 13. Embodiments can also be envisaged without the nacelle 13 or where the generator 7 is not located in the nacelle 13. The generator 7 may be arranged in a way described in, for example, EP 1327073 B1. In FIG. 2, it is showed how the generator 7 may be designed and arranged such that a turbine shaft 4 that is driven by the turbine blades 2 drives the rotor 9 of the generator 7. In FIG. 2, the drive shaft 4 is held in bearings 5, 6 and a final part of the turbine shaft 4 is rigidly connected to the rotor 9. The reference numeral 8 designates the stator. The turbine shaft 4 is preferably rigidly connected to the turbine blades. In this way, generator 7 and the turbine blades 2 are directly connected to each other without any intermediate gear, the rotor 9 rigidly follows the movement of the turbine blades 2. However, the generator 7 may also be designed in other ways. For reasons that will be explained, it is preferred that the turbine blades 2 are directly connected to the generator 7 without any intermediate gear. However, embodiments are also conceivable where there is an intermediate gear between the turbine blades 2 and the generator 7.

With reference to FIG. 3, one or several ice detectors 10 may advantageously be placed on or below the surface of one or several turbine blades 2. Such a detector can be used to detect the presence of a layer of ice 12 on the surface of a turbine blade 2. With reference to FIG. 1, a detector 10 must not necessarily be placed on a turbine blade 2. As an alternative, a detector 10 may be placed in a zone surrounding the wind power plant 1. Such a detector 10 (or a group of detectors 10) could monitor one or several conditions that are likely to result in the formation of ice on the turbine blades 2. For example, detectors 10 could monitor temperature and precipitation or air humidity. If it is known that certain combinations of temperature and precipitation or air humidity are likely to lead to the formation of ice, this can be used to formulate a condition that is deemed indicative of ice formation on the turbine blades. Such a monitoring can be understood as an indirect detection of ice. Instead of directly detecting ice, a condition is detected that signals an increased likelihood that is has formed. When one or several detectors 10 are located in a zone surrounding the wind power plant, they should preferably be located relatively near the wind power plant such that the conditions they monitor are relevant for the conditions on the turbine blades 2. For example, they may be located within 500 meters from the hub around which the turbine blades 2 rotate.

It should be understood that many different parameters may be used to determine if ice has formed on the turbine blades 2, or whether it can be suspected that ice has formed. For example, the output from the wind power plant can be monitored and compared to an expected value at a given wind speed. The wind speed is measured and based on the speed of the wind, calculation or previous experience can be used to determine what the output from the wind power plant ought to be. If the actual output is lower, this may be an indication that ice has formed on the rotor blades 2. A lower output than expected can then be treated as an indication that ice gas formed. Generally speaking, it can thus be stated that the wind power plant 1 has equipment 10, 11 arranged to detect whether a criterion indicative of ice formation on the turbine blades 2 is satisfied. If this criterion is satisfied, the generator 7 will be caused to drive the rotor blades alternatingly in opposite directions.

With reference to FIG. 1, the wind power plant may comprise a control unit 11, for example a computer. In FIG. 1, the control unit 11 is showed outside the nacelle 13 and the tower 3. In many practical embodiments, the control unit may also be located inside the nacelle 13 or in the tower 3. The control unit 11 may be connected to the generator 7 an arranged to monitor output from the wind power plant, possibly with the aid of a special measuring unit or detector 10 for measuring output.

The basic idea of various aspects of the invention will now be explained with reference to FIG. 4. The turbine blades 2 are monitored by means of one or several detectors 10 to determine whether ice has formed on the turbine blades or not. Alternatively, a zone a zone around the wind power plant is monitored. It should be understood that the detector 10 that is showed in FIG. 1 may take many different shapes. For example, the detector 10 could be a wind speed detector or a thermometer. Although only one detector 10 is showed, it should be understood that many detectors 10 may be used. When many detectors are used, they can also be designed to measure and/or detect different parameters. For example, one detector could be designed to measure temperature while another detector 10 is designed to measure and/or detect precipitation while yet another detector 10 is used to measure wind speed. A separate detector 10 or measuring device may also be used to measure or determine the rotational speed of the turbine blades 2. A detector 10 could also be integrated with the generator 7 and/or the control unit 11 and arranged to measure output from the wind power plant.

The detector 10 or detectors 10 could also be ice detectors 10 that are located in or on the rotor blades 2. An example of a sensor that can be used to detect ice is disclosed in U.S. Pat. No. 5,206,806 and such a sensor could be used also in connection with the present invention.

If one or several detectors 10 indicate that ice has formed on the turbine blades 2, or, if one or several detectors 10 indicate a condition where the formation of ice is considered likely, it is deemed that a criterion indicating that ice 12 has formed on the turbine blades 2 is satisfied. It should be understood that, in many realistic embodiments, the detectors 10 would cooperate/interact with the control unit 11 when it is determined that the criterion for ice formation is satisfied. However, it is also possible that an operator simply looks at one or several detectors 10 and determines whether the criterion is satisfied or not. Embodiments of the inventive method are also conceivable where ice detection is determined simply by visual inspection of the wind power plant. A human operator may look at the wind power plant and determine whether he believes that ice has formed. If, after looking at the wind power plant, the operator believes that ice has formed on the rotor blades, then a criterion indicating that ice has formed on the turbine blades 2 is satisfied.

If this criterion is satisfied, a de-icing operation is performed on the turbine blades 2 to remove ice from the turbine blades. As schematically indicated in FIG. 4, the de-icing operation comprises driving the turbine blades 2 of the wind power plant 1 alternatingly in opposite directions. Thereby, vibrations will be generated in the turbine blades 2 and these vibrations will cause ice to leave the surface of the turbine blades 2.

As indicated in FIG. 4, the turbine blades 2 may possibly retain their angular orientation during the de-icing operation. However, the de-icing operation can be made more effective if, before the de-icing operation is carried out, the turbine blades 2 are turned away from the direction of the wind such that the area of the turbine blades 2 that faces the wind is reduced.

With reference to FIG. 5a and FIG. 6a, the turbine blades 2 will, during normal operation of the wind power plant 1, usually be turned such that they are essentially facing the wind, i.e. the side facing the wind is relatively flat. If the turbine blades are driven back and forth in this position, the stiffness of the blades 2 in the plane of rotation of the blades 2 will be relatively high which makes it more difficult to generate strong vibrations in the turbine blades 2.

To make it easier to generate strong vibrations in the turbine blades 2, the turbine blades 2 can be turned before the de-icing operation is carried out such that, in the plane in which the turbine blades 2 rotate, the bending stiffness of the turbine blades 2 is reduced. From a starting position in which the turbine blades 2 are facing the wind, this means that the turbine blades are turned away from the wind such that the area of the turbine blades 2 that face the wind is reduced.

Preferably, the turbine blades 2 are turned to such an extent that, in the plane in which the turbine blades 2 rotate, the bending stiffness of the turbine blades 2 is minimized

If the turbine blades 2 are rotating when the criterion that indicates that ice has formed is satisfied, the speed of the rotation of the turbine blades 2 is reduced before the de-icing operation is carried out. Preferably, the movement of the turbine blades 2 is completely halted before the de-icing operation is initiated. By slowing down or halting the turbine blades 2 before de-icing is initiated, the de-icing operation will become more effective and the risk of damage to the turbine blades or other equipment is reduced. Normally, the turbine blades 2 would be halted by pitching the blades to feather, i.e. pitching the blades to a position where they no longer catch the wind. Alternatively, a separate brake may be used to slow down or halt the movement of the turbine blades 2. The generator 7 itself could also be used as a brake for the turbine blades. Thereby, the advantage is gained that no separate braking device is needed.

In FIG. 5b and FIG. 6b, it can be seen how the turbine blades 2 have been turned such that they have minimal stiffness in the plane in which the turbine blades 2 are to be rotated/driven alternatingly in opposite directions during de-icing. As a consequence the turbine blades 2 will bend relatively easy which is schematically indicated in FIG. 7.

With reference to FIG. 8, it can be seen how a layer of ice 12 has formed on the surface of a turbine blade 2. FIG. 9 shows how the turbine blade 2 is bending due to vibrations that has been generated in the turbine blade 2 by the act of driving the turbine blades 2 alternatingly in opposite directions. As a consequence, pieces of ice 12 break loose from the turbine blade 2 and ice is removed from the turbine blade 2.

In principle, the de-icing operation can be initiated directly after it has been detected that ice has formed. This can mean that the turbine blades 2 are already rotating when the de-icing operation is initiated. However, this would probably be unrealistic unless the turbine blades were to rotate at a very low speed. Normally, it would be necessary to halt the turbine blades 2 completely before the de-icing operation is carried out. Alternatively, the rotation of the turbine blades 2 could be slowed down to a very low level.

When the turbine blades 2 are driven alternatingly in opposite directions, this may preferably be done at a frequency that is selected to generate self-oscillation in the turbine blades 2, the natural frequency. In this way, self-vibrations in the turbine blades 2 can be induced such that the vibrations become more forceful. The choice of frequency may thus depend on the dimensions of the turbine blades 2 in each single case. In many realistic embodiments, the actual frequency may be on the order of about one (1) Hertz.

In principle, the turbine blades 2 may be driven by anything that is capable of driving the turbine blades alternatingly in opposite directions. A separate drive unit may be provided for this purpose. However, in preferred embodiments of the invention, the de-icing is carried out by the generator 7 which is itself driven by the turbine blades during normal operation of the wind power plant. When the generator 7 is used to drive the turbine blades 2, a separate drive unit is not needed. This makes the wind power plant 1 less expensive and less complicated to build.

In principle, the generator 7 may be arranged to drive the turbine blades 2 through an intermediate gear. In such a case, the generator 7 would itself probably be driven by the turbine blades 2 through the intermediate gear. However, in preferred embodiments of the invention, the generator 7 (together with the turbine shaft 4) is arranged to drive the turbine blades 2 directly without using any intermediate gear. This also means that, during normal operation, the generator 7 is driven directly by the turbine blades 2 and their turbine shaft 4 without any intermediate gear. Such an embodiment is preferable since an intermediate gear would risk being damaged if the direction of movement were to be changed rapidly back and forth. The generator 7 is then arranged to be able to drive the turbine blades 2 alternatingly in two opposite directions.

After the de-icing operation has been carried out, the turbine blades 2 may be monitored to determine whether there is still ice 12 on the turbine blades. If it is determined that the turbine blades 2 are sufficiently ice-free, the wind power plant 1 can be operated to generate electricity. If not, a new de-icing operation can be performed.

With reference again to FIG. 1, the control unit 11 is suitably connected to the detector(s) 10 and to the generator 7. In response to a signal from the detector(s) 10 that indicates the presence of ice on one or several turbine blades 2, the control unit 11 may be programmed to cause the generator 7 to drive the turbine blades 2 alternatingly in two opposite directions.

It should be understood that the use of detectors 10 is optional. This is the case since monitoring for ice formation can be achieved by means of visual inspection by a human operator. It should also be understood that the control unit 11 is also optional. Embodiments are conceivable where a human operator directly controls the operation of the generator 7.

Although the invention has been described above in terms of a method and a wind power plant, it should be understood that these categories only reflect different aspects of one and the same invention. The wind power plant is designed to carry out the inventive method. In the same way, the method may also comprise such steps that would be the result of operating the equipment of the wind power plant, even if such steps have not been explicitly mentioned.

What is claimed is:

1. A method for operating a wind power plant having turbine blades on which ice has formed, the method comprising a de-icing operation to remove the ice from the turbine blades, and wherein the de-icing operation comprises driving the turbine blades of the wind power plant alternatingly in opposite directions such that vibrations in the turbine blades are generated, wherein, before the de-icing operation is carried out, the turbine blades are turned such that, in the plane in which the turbine blades rotate, the bending stiffness of the turbine blades is reduced.

2. A method according to claim 1, wherein the method also comprises performing a monitoring operation to determine if a criterion that indicates that ice has formed on the turbine blades is satisfied and performing the de-icing operation if this criterion is satisfied.

3. A method according to claim 1, wherein, before the de-icing operation is carried out, the turbine blades are turned such that, in the plane in which the turbine blades rotate, the bending stiffness of the turbine blades is minimized.

4. A method according to claim 1, wherein, if the turbine blades are rotating when the criterion that indicates that ice has formed is satisfied, the speed of the rotation of the turbine blades is reduced before the de-icing operation is carried out.

5. A method according to claim 1, wherein the turbine blades are first halted completely before the de-icing operation is carried out.

6. A method according to claim 1, wherein, during the de-icing operation, the turbine blades are driven alternatingly in opposite directions at a frequency that is selected to generate self-oscillation in the turbine blades.

7. A method according to claim 1, wherein, during the de-icing operation, the turbine blades are driven by a generator of the wind turbine which generator is driven by the turbine blades during normal operation of the wind power plant and wherein, during the de-icing operation, the generator drives the turbine blades directly without using any intermediate gear.

8. A method according to claim 1, wherein, after the de-icing operation has been carried out, the turbine blades are monitored to determine whether there is still ice on the turbine blades and, if it is determined that the turbine blades are sufficiently ice-free, the wind power plant is operated to generate electricity.

9. A method according to claim 2, wherein the monitoring operation comprises measuring the actual output from the wind power plant and comparing it to an expected output.

10. A wind power plant having a generator, and turbine blades arranged to drive the generator such that electrical power is generated, and wherein the generator is arranged to be able to drive the turbine blades alternatingly in two opposite directions, wherein the wind power plant comprises a control unit and wherein the wind power plant is designed to turn the turbine blades, before a de-icing operation, such that in the plane in which the turbine blades rotate, the bending stiffness of the turbine blades is reduced.

11. A wind power plant according to claim 10, wherein the wind power plant comprises equipment arranged to detect whether a criterion indicative of ice formation on the turbine blades is satisfied.

12. A wind power plant according to claim 10, wherein the generator and the turbine blades are directly coupled to each other without any intermediate gear.

13. A wind power plant according to claim 10, wherein the control unit is connected to the generator and at least one detector arranged to detect the presence of ice on the turbine blades or a condition in a zone around the wind power plant that is indicative of ice on the turbine blades and wherein the at least one detector is connected to the control unit and wherein the control unit is arranged to cause the generator to drive the turbine blades alternatingly in two opposite direction if the control unit receives a signal from the at least one detector that indicates the presence of ice on one or several turbine blades.

14. A wind power plant according to claim 10, wherein the control unit that is connected to the generator and arranged to monitor output from the wind power plant is operable to, compare the actual output to an expected output and cause the generator to drive the turbine blades alternatingly in opposite directions if the actual output is lower than the expected output.
